(19) United States
(12) Patent Application Publication
(10) Pub. No.: US 2016/0247125 A1
(43) Pub. Date: Aug. 25, 2016

(54) R We Still On Time? An Active Approach for Aggregating 2-Way Re-confirmations in Electronic Calendaring Systems

(71) Applicant: Dane Matthew Theisen, Adrian, MI (US)

(72) Inventor: Dane Matthew Theisen, Adrian, MI (US)

(21) Appl. No.: 14/630,089

(22) Filed: Feb. 24, 2015

(51) Int. Cl. G06Q 10/10

(52) U.S. Cl. CPC G06Q 10/1095

(57) ABSTRACT

People waiting without knowing how long—it's a universal problem, it's everywhere. Time is finite and therefore precious; you cannot recapture lost time waiting. Coordinating precise meeting times among groups of people, can be a difficult task; a chore that seemingly never goes according to the exact plan. There is almost certainly a margin of error—plus or minus minutes, while in the scope of a short-lived human life, every priceless minute counts.

R We Still On Time? Herein described is a method for providing real-time status updates to expectant people so they can make better use of unproductive time normally spent waiting. Currently, when using electronic calendaring, attendees have no control over how long they are going to wait for other attendees to arrive to the scheduled event, either in person or via electronic communication. It's merely a guessing game as to when a calendar event will actually begin versus when it was scheduled to begin. In this manner, much time is exhausted on a wasteful activity; waiting. Thus, waiting can be defined as the idle action of staying where one is or delaying further action until a particular time or until something else happens.

The present invention relates to time synchronization and in particular to a method and systematic approach to confirming and reconfirming specific meeting times between two or more meeting attendees in immediate, real time. In a situational context, an attendee could be a customer, client, patient, family member, friend, boyfriend/girlfriend, ect. The described approach allows meeting attendees to re-confirm and specify whether the agreed calendar event time is correct and withstanding. Reconfirmation can be accomplished using a data linked vehicle head unit that supports electronics communication devices or other electronic communication device such as a desktop or laptop computer, tablet, mobile device or smart-watch or smart accessory that may be worn, imbedded into or controlled by a human operator.

The unique unique features of the invention are set forth in the detailed specification. The invention itself however, as well as a preferred mode of use will best be understood when read in conjunction with the accompanying abstract and technical drawings, wherein:

(FIG. 1) Upon first use of the system, a splash screen is presented to the user with an action button to view and sync their existing calendar from a third party service such as Google Calendar. (FIG. 2)When the action button is pressed, a prompting screen with a list of 3^{rd} party calendar services appears for the user to choose from. (FIG. 2.1) When the user selects a calendar service, a login screen appears for the service where unique account credentials for the service can be entered, such as user name and password. Once authenticated, the user may then grant permission to R We Still On Time? to view and sync calendar details stored in the calendars service's data base, this is done using the API provided by the calendar service. An API, an abbreviation of application program interface, is a set of routines, protocols, and tools for building software applications. (FIG. 3) When all preferred calendars have been synced by the user (one or multiple calendars), a settings screen is presented. The settings screen prompts the user to choose a default time based group re confirmation notification that will auto fill the 2 way (Group) reconfirmation field in FIG. 8 when the user creates a new event. This settings feature is intended to save time for user. In this manner, the user can set a preference to autofill their 2 way (group) reconfirmation prompt when creating a new calendar event. Though, this default setting can be overridden, and a custom time based re confirmation can be chosen when the user edits an existing event or creates a new calendar event.

(FIG. 4) The user can view existing calendar events synced to the user interface from a third party calendar service such as Google Calendar. The existing calendar event displays saved information from the third party calendar data base in which it created, such event title, date, time, location and the event originator. The display also includes an action button to edit the event, options to add additional attendees, as well as action buttons to communicate or synchronize their estimated time of arrival for the event with the other attendees. (FIG. 5) When the user has chosen the action button to edit the event an existing calendar event, information for the existing event is provided by the 3^{rd} party calendar service data base in which it originated including: an event title, location, a specific date and start time, a specific reconfirmation notification prompt time and attendee contact information. Additional attendees can be added from a stored contact list. This 2 way re confirmation prompt time is stored in the centralized server outlined in the flow chart in FIG. 27. (FIG. 5.1) is a pictorial representation of a stored contact list. This list may be stored on a cloud database and viewed or stored on the internal or external hard drive connected to the electronic communication device. This contact information is shown visually on the interface as a short nickname (Ex: 419 xxx xxxxx is Person B or PersonB@gmail.com is Person B). In the pictorial representation Person B is chosen from the stored contact list and added to the list of attendees.

FIG. 6 Once the event details have been saved, the updated user interface appears displaying event details such as date, time, location and meeting attendees including contact information such as phone numbers and email addresses of each attendee. This contact information is shown visually on the interface as a nickname (Ex: 419 xxx xxxxx is Person B or PersonB@gmail.com is Person B). The event display also includes an action button to edit the event, options to add additional attendees, as well as action buttons to communicate or synchronize their estimated time of arrival for the particular event with the other attendees. (FIG. 7) is a pictorial representation of an action button to add a new event. (FIG. 8) The user has the ability to create a new calendar event. In doing so, a prompting screen is presented to a meeting originator with blank text fields including: an event title, location, a specific date, a specific time. A list of attendees and a 2 way re confirmation prompt time also need to be determined. (FIG. 9) A prompting message and action button is presented to each attendee at the specified re confirmation time interval via electronic communication, prompting the attendee to send a response indicating that the original meeting date and time are still valid. Time status reconfirmation can be accomplished using a data linked vehicle head unit (FIG. 26) that supports electronics communication devices or other electronic communication device such as a desktop or laptop computer, tablet, mobile device or smart watch or smart accessory that may be worn, imbedded into or controlled by a human operator. This initial reconfirmation message (R We Still On Time for event tile?) is sent out by a centralized server in the form of a Push Notification if the client app has been installed on the attendees communication device. A server can be defined as a computer program running on computer hardware to serve the requests of another program application, the client. Thus, the server performs some tasks on behalf of the client application. In this case, the client application is R We Still On Time?, and task being performed by the server are the delivery of time triggered prompting messages to each meeting attendee. (FIG. 10) A prompting message is presented to all members of the meeting group at the specified re confirmation time interval via electronic communication in the form of SMS Text Message, Email with a click able web link (if the user doesn't have the client application installed on their communication device).

(FIG. 11) Once the web link in FIG. 10 clicked, a user interface is presented to the event attendee that doesn't have the application installed. This graphic interface will permit the sending of an individualized response to the server indicating whether the event start time is still valid. The responses being, Still on Time, Running. Minutes Ahead, Running Minutes Behind, or Sorry Can't make it. (FIG. 12) A confirmation screen is presented after choosing re confirmation response “Still On Time”. (FIG. 13) A time interval screen that is presented after choosing re confirmation response “Running Ahead”. (FIG. 14) A confirmation screen is presented after choosing a time interval and sending the re confirmation response “Running Ahead”. (FIG. 15) A time interval screen that is presented after choosing re confirmation response “Running Late”. (FIGS. 16 & 17) A confirmation screen is presented after choosing a time status”. (FIG. 18) Once each attendee has chosen a time status, the centralized server sends a push notification that summarizes the estimated time of arrival for each event attendee. The centralized server in the flow chart in FIG. 27 will send a push notification by default if the attendee has the client app is installed on the communication device being used. FIG. 19 If the client application is not installed on the communication device, the centralized server sends an SMS Text or Email to each attendee that summarizes the estimated time of arrival for each event attendee. Time status responses are also aggregated on the user interface. (FIG. 20) For example, the interface has been updated to confirm and display that Person A is 10 minutes late for the meeting while Person B is still on time. (FIG. 21) When using the client application, users may search a contact list based on average wait time, for other users whom have the client application installed on their communication device such as service providers, Wait time being an average measure of how far the service provider (other user) deviates from calendar event start times. For example, Dr. ABC has an average wait time of 5 minutes. While, Dr. EFG has an average wait time of 10 minutes. This means patients are usually left waiting for on average 5 minutes past the agreed start time of the event. Considering that Dr. ABC has a lower average wait time he or she will show up first in search results. Average customer wait time is calculated based on the average of the time status responses of service provider. Ex: Still On Time, Running Minutes Ahead, Running minutes late, or Sorry can't make it.

(FIGS. 22.2 & 23) The 2 way active system outlined in the detail description differs from systems such a Google Calendar & Microsoft Outlook that offer one way passive reminder notifications that merely remind the user about the events start time with options to dismiss the notification or snooze: to repeat the passive reminder notification at a later time. The 2 way active system outlined also differs from Tempo AI Calendar that only allows the event originator to let a particular attendee know that they are running late, vs the entire meeting group (FIGS. 24 & 24.1) In the Tempo AI system there is no time triggered prompt to request the entire group of event attendees to submit their time status or aggregation of submitted time statuses from event attendees.

### BRIEF DESCRIPTION OF THE DRAWINGS

The unique features of the invention are set forth in the appended claims. The invention itself however, as well as a preferred mode of use will best be understood when read in conjunction with the detailed description of the specification, wherein:

FIG. 1 is a pictorial representation of a splash screen.

FIG. 2 is a pictorial representation of a prompting screen with a list of calendars for the user to choose from.

FIG. 2.1 is a pictorial representation of a login screen.

FIG. 3 is a pictorial representation of a settings screen.

FIG. 4 is a pictorial representation of an existing calendar event.

FIG. 5 is a pictorial representation of a prompting screen to edit an existing calendar event.

FIG. 5.1 is a pictorial representation of a stored contact list.

FIG. 6 is a pictorial representation of an updated user interface displaying event details.

FIG. 7 is a pictorial representation of an action button to add a new event.

FIG. 8 is a pictorial representation of a prompting screen to create a new calendar event.

FIG. 9 is a pictorial representation of a prompting message and action button.

FIG. 10 is a pictorial representation of a prompting message that is presented to all members of the meeting group at the specified re confirmation time interval.

FIG. 11 is a pictorial representation of a user interface that is presented to the attendee upon clicking on the action button.

FIG. 12 is a pictorial representation of a confirmation screen that is presented after choosing re confirmation response “Still On Time”.

FIG. 13 is a pictorial representation of a time interval screen that is presented after choosing re confirmation response “Running Ahead”.

FIG. 14 is a pictorial representation of a confirmation screen that is presented after choosing a time interval and sending the re confirmation response “Running Ahead”.

FIG. 15 is a pictorial representation of a time interval screen that is presented after choosing re confirmation response “Running Late”.

FIG. 16 is a pictorial representation of a confirmation screen that is presented after choosing a time interval and sending the re confirmation response “Running Late”.

FIG. 17 is a pictorial representation of a confirmation screen that is presented after sending the response “cancel & reschedule”.

FIG. 18 is a pictorial representation of a push notification sent by the centralized server.

FIG. 19 is a pictorial representation of a SMS Text or Email sent by the centralized server.

FIG. 20 is a pictorial representation of a user interface in which meeting confirmation responses are aggregated.

FIG. 21 is a pictorial representation of Search ranking based on average customer wait time.

FIG. 22 is a pictorial representation of Outlook calendar request response for attendance. Meeting time negotiation.

FIG. 22.1 is a pictorial representation of Outlook new event form.

FIG. 22.2 is a pictorial representation of Outlook 1 Way passive reminder. Snooze or Dismiss. U.S. 20070229517

FIG. 23 is a pictorial representation Google Calendar notifications via email or pop up.

FIG. 23.1 is a pictorial representation of Google Calendar reminder.

FIG. 24 is a pictorial representation of Tempo AI Calendar passive 1 way personal reminder.

FIG. 24.1 is a pictorial representation of Tempo AI Calendar 1 Way notification system.

FIG. 25 is a pictorial representation of Estimated time of arrival via GPS Tracking.

FIG. 26 is a pictorial representation of a Data linked vehicle head unit that supports electronics communication devices.

FIG. 27 is a flow chart of the specification process.

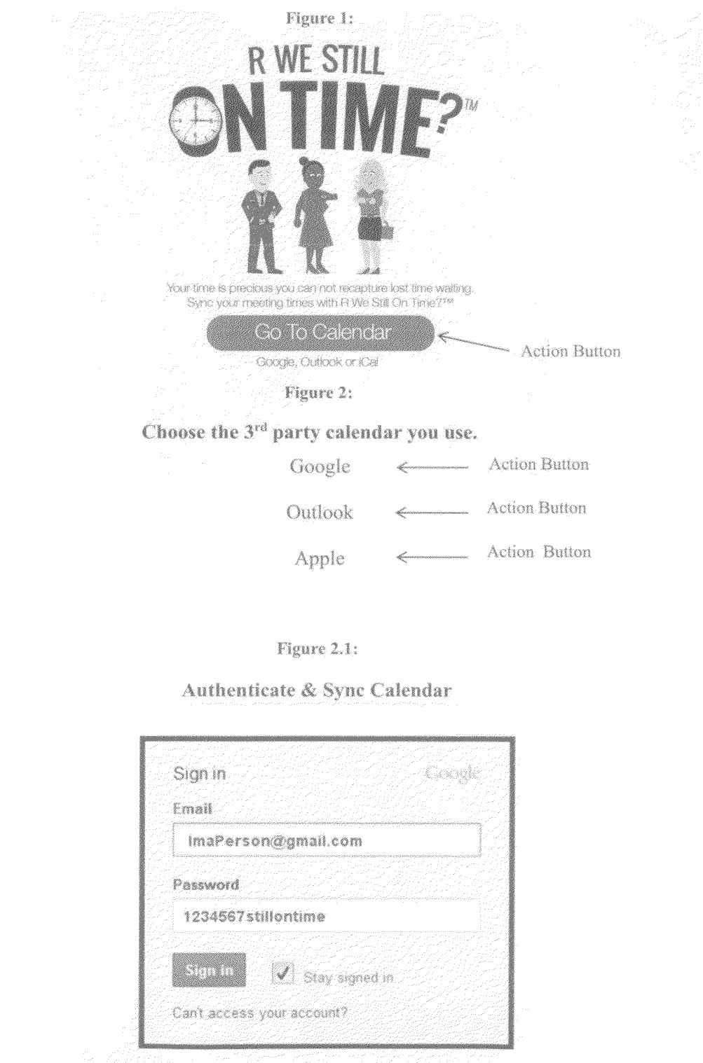

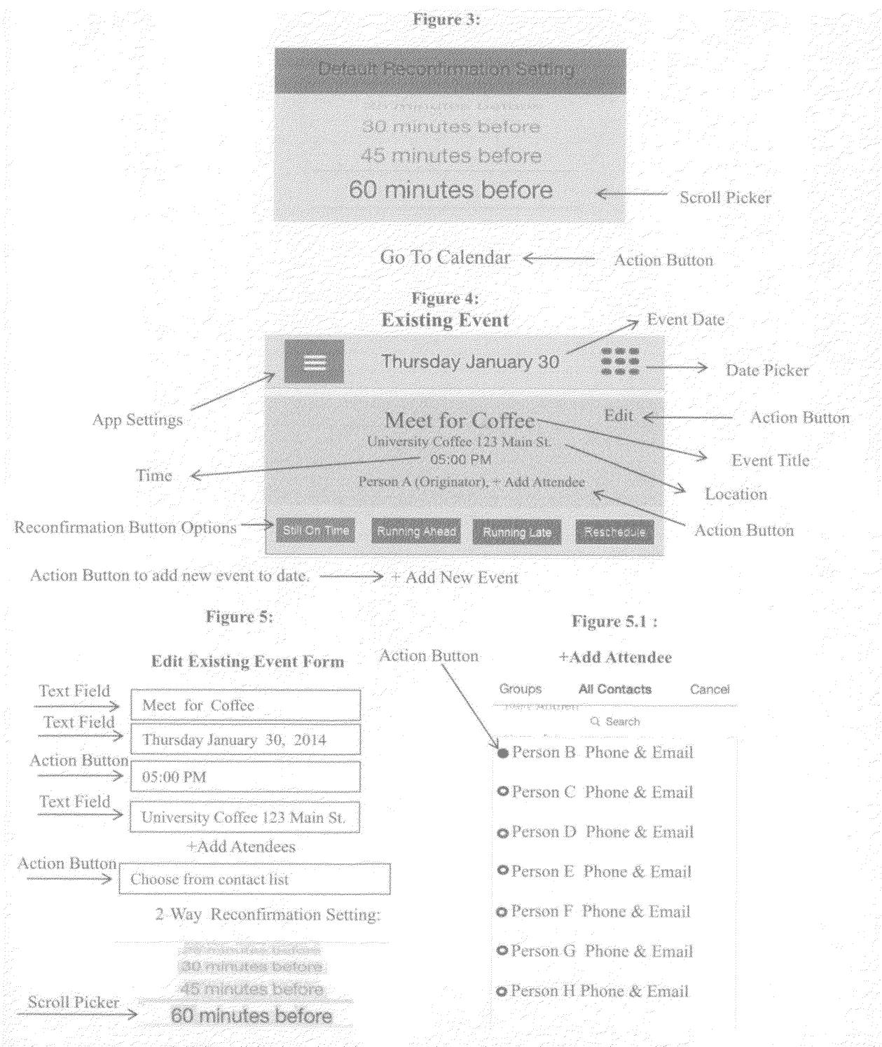

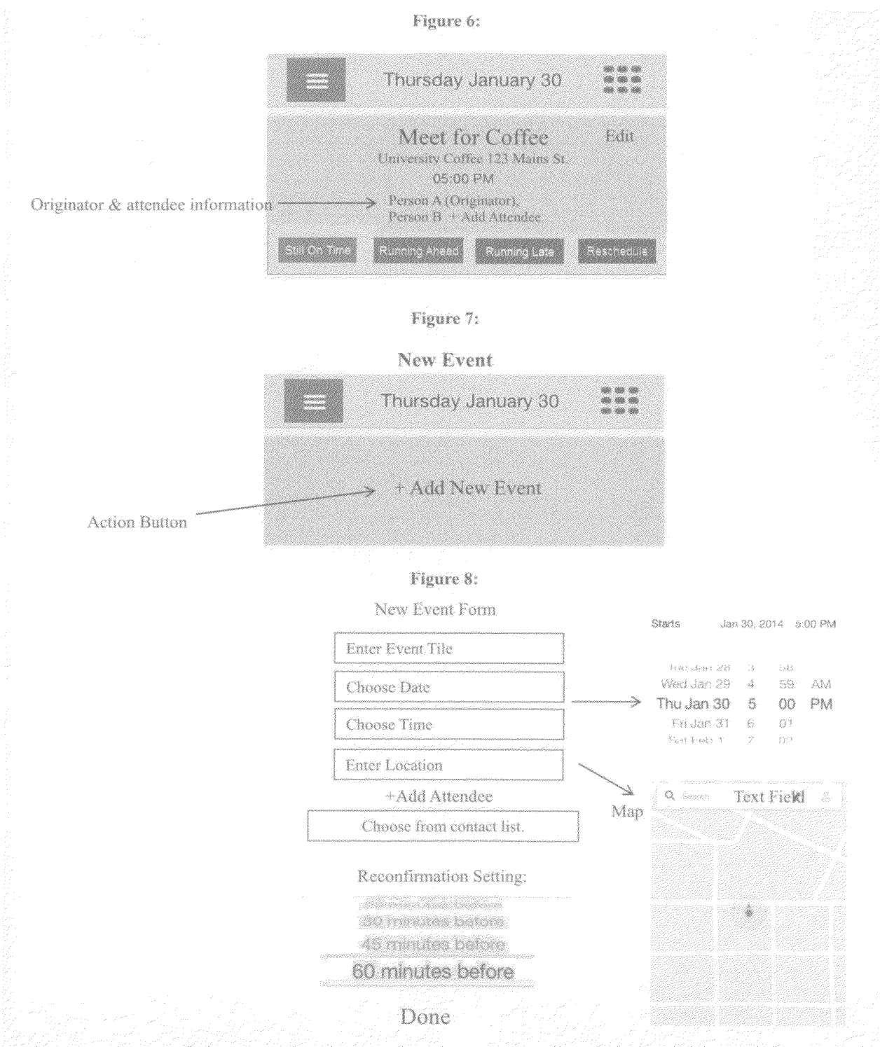

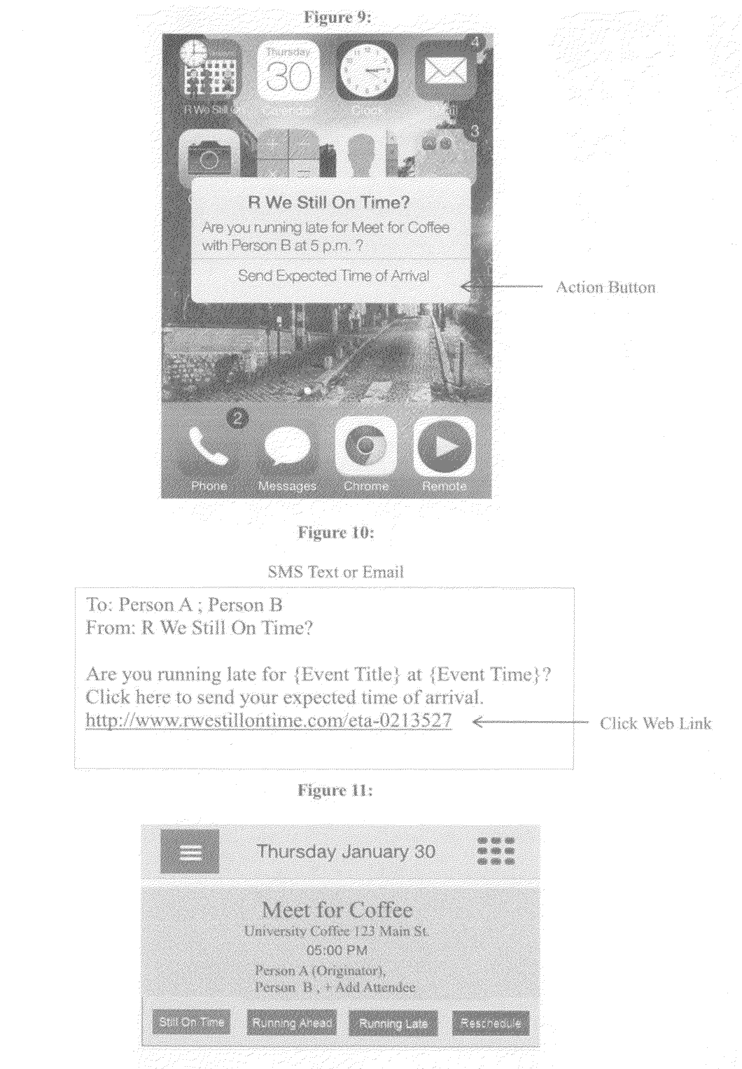

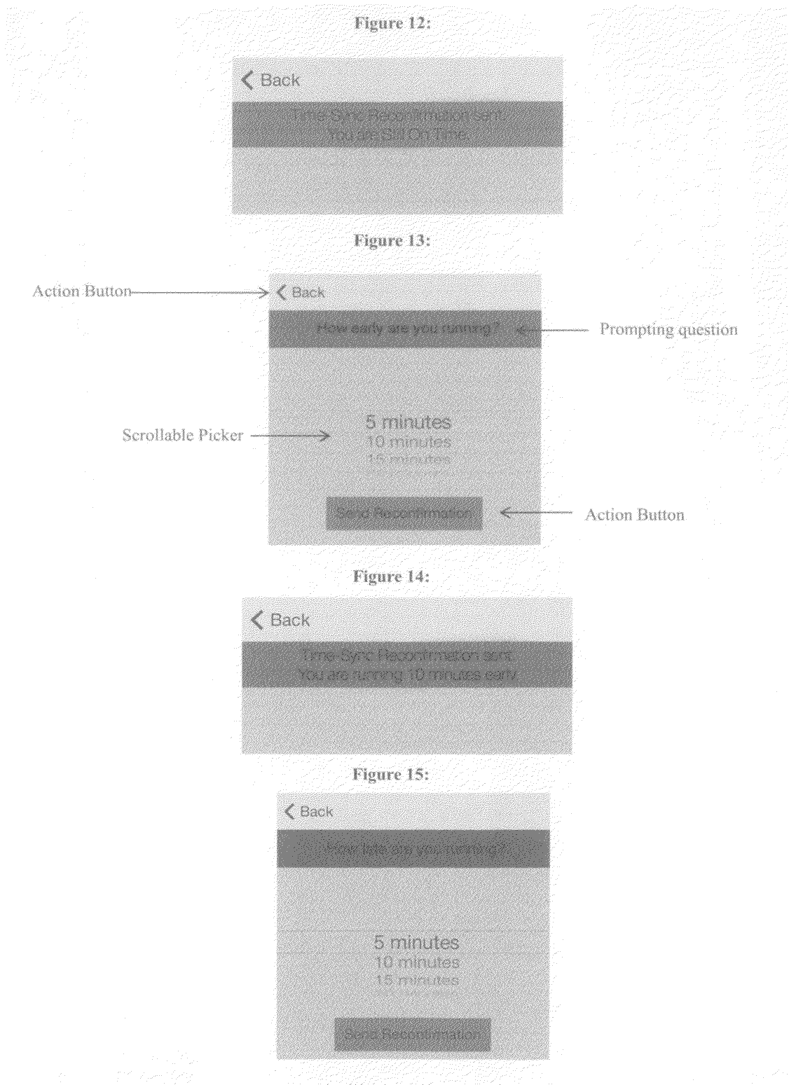

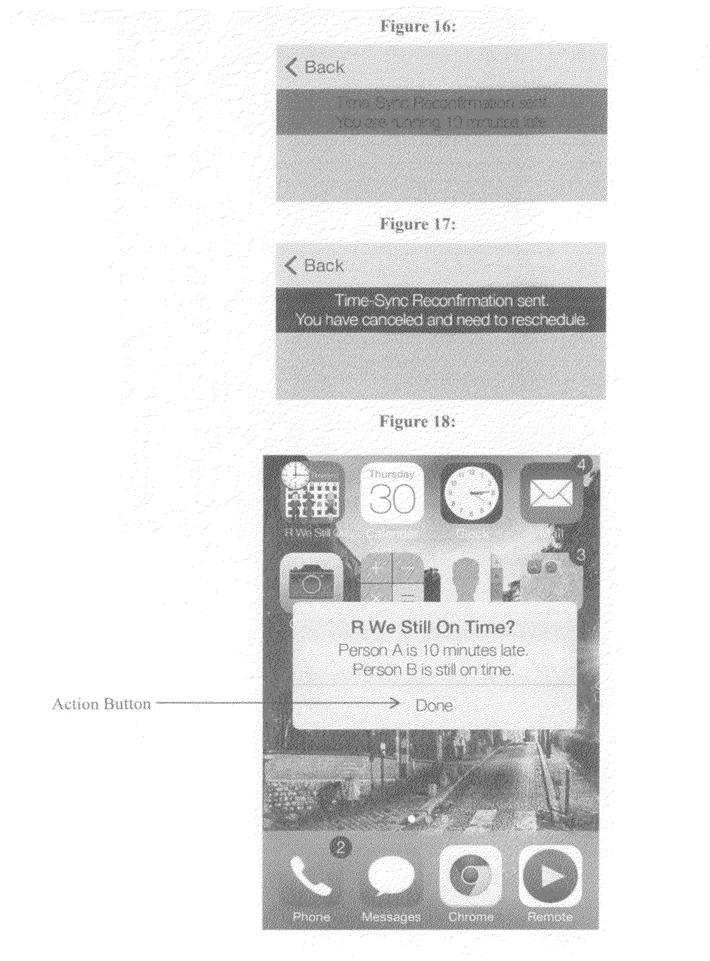

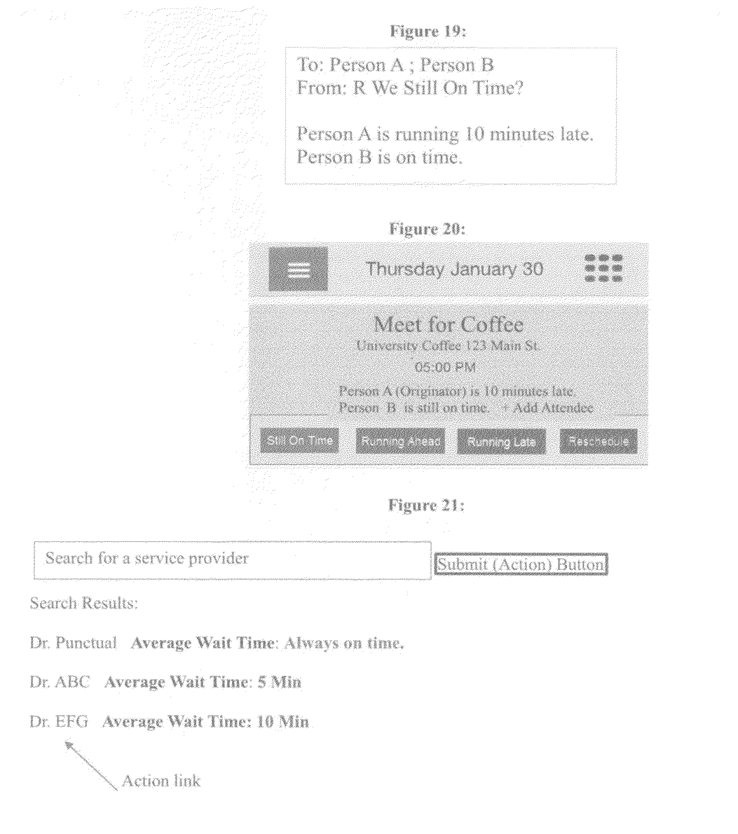

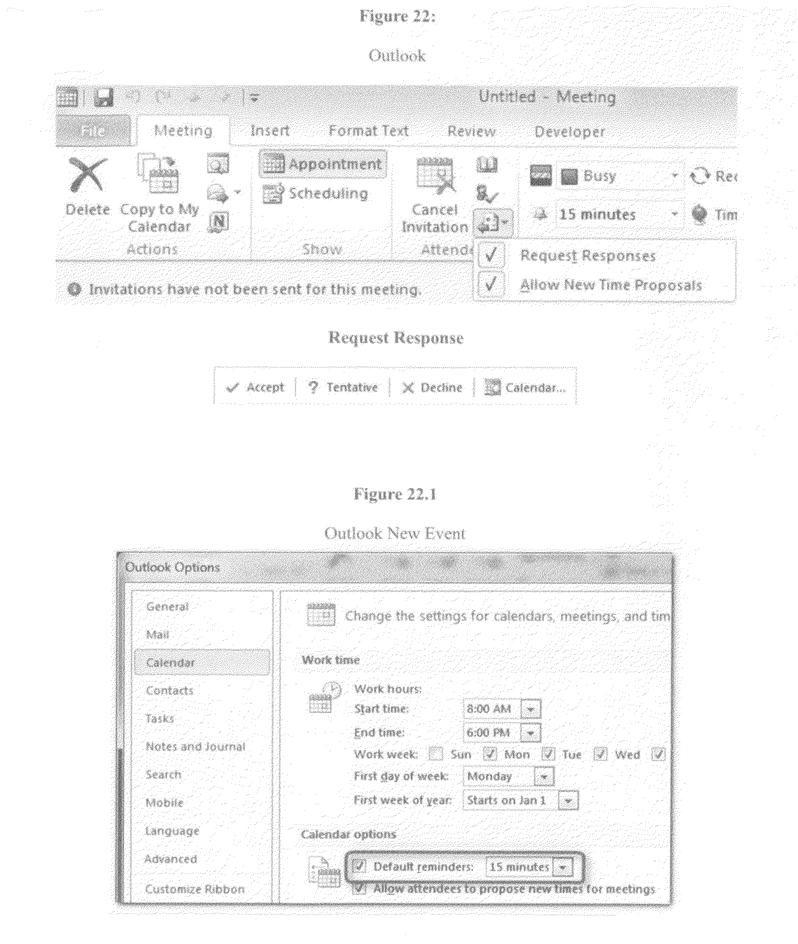

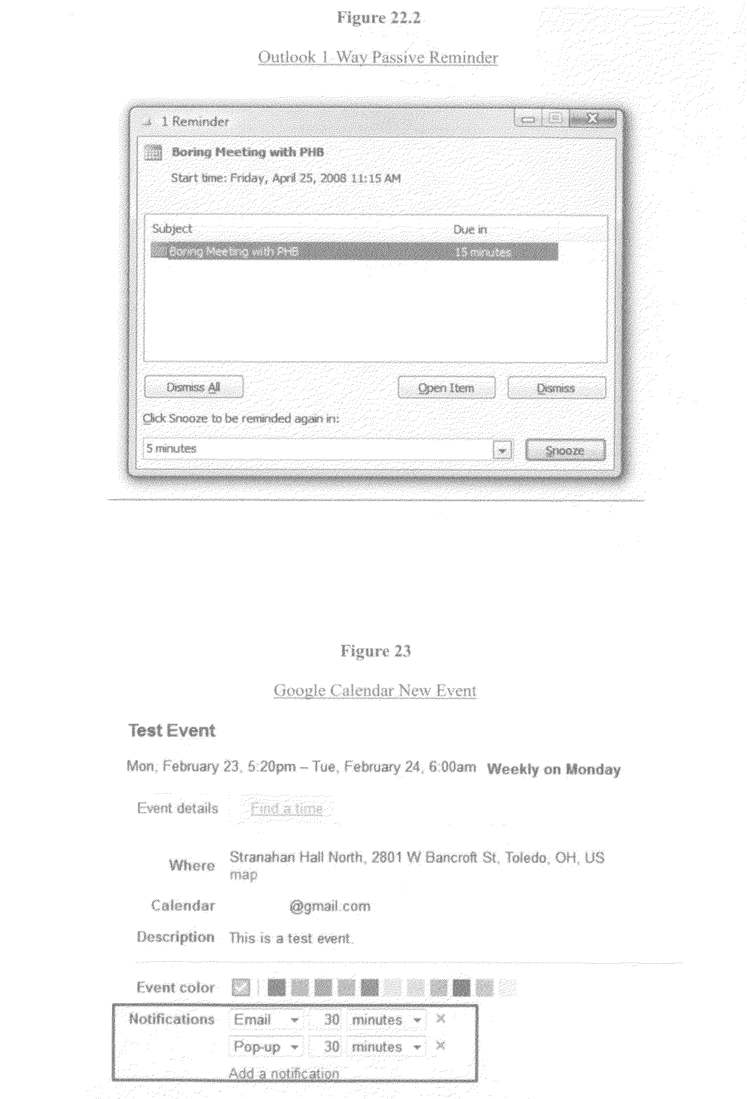

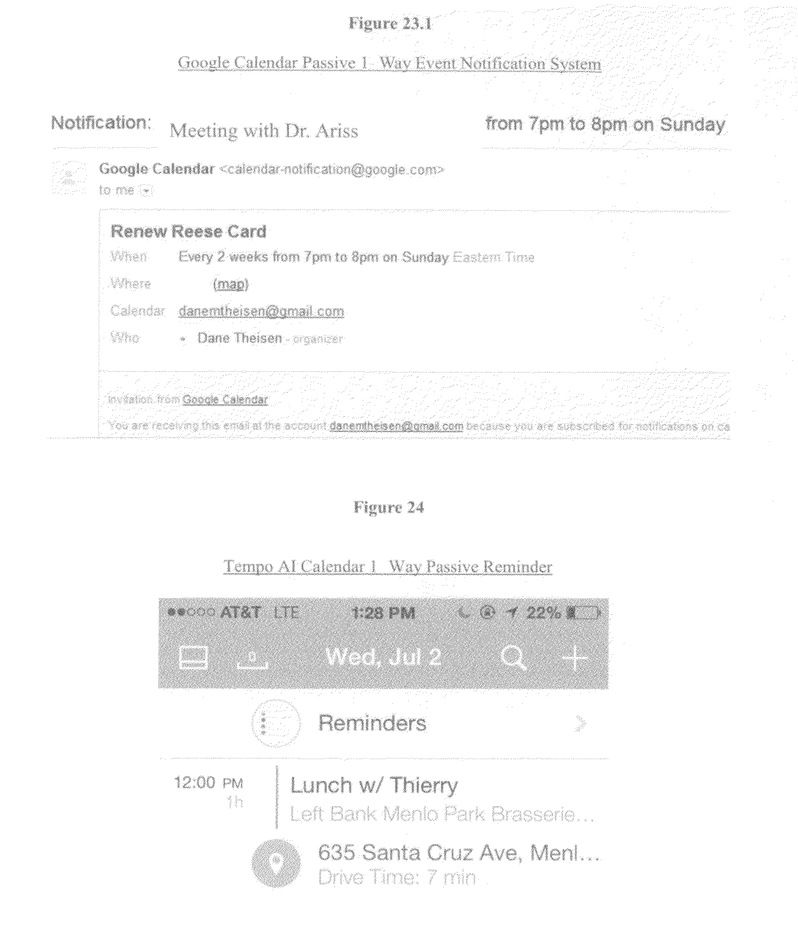

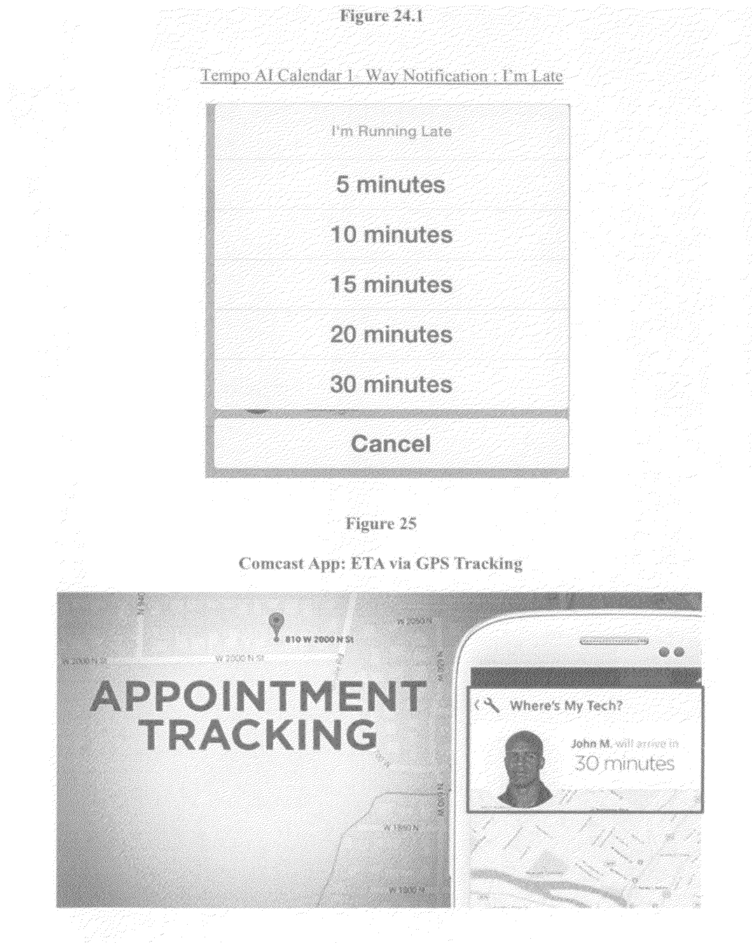

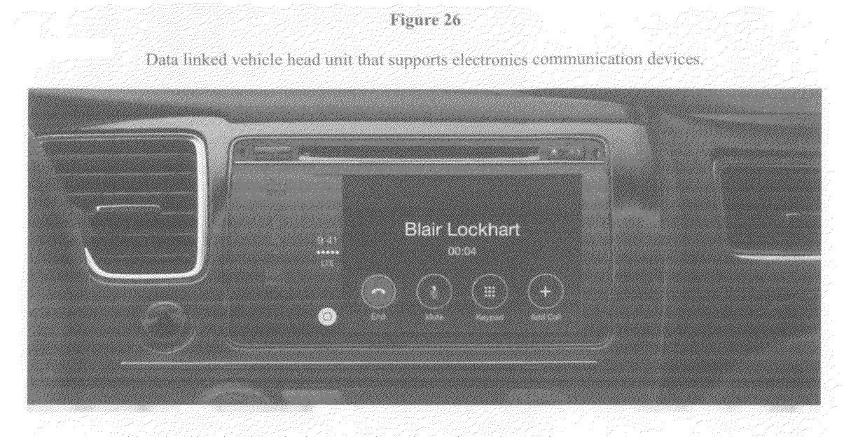

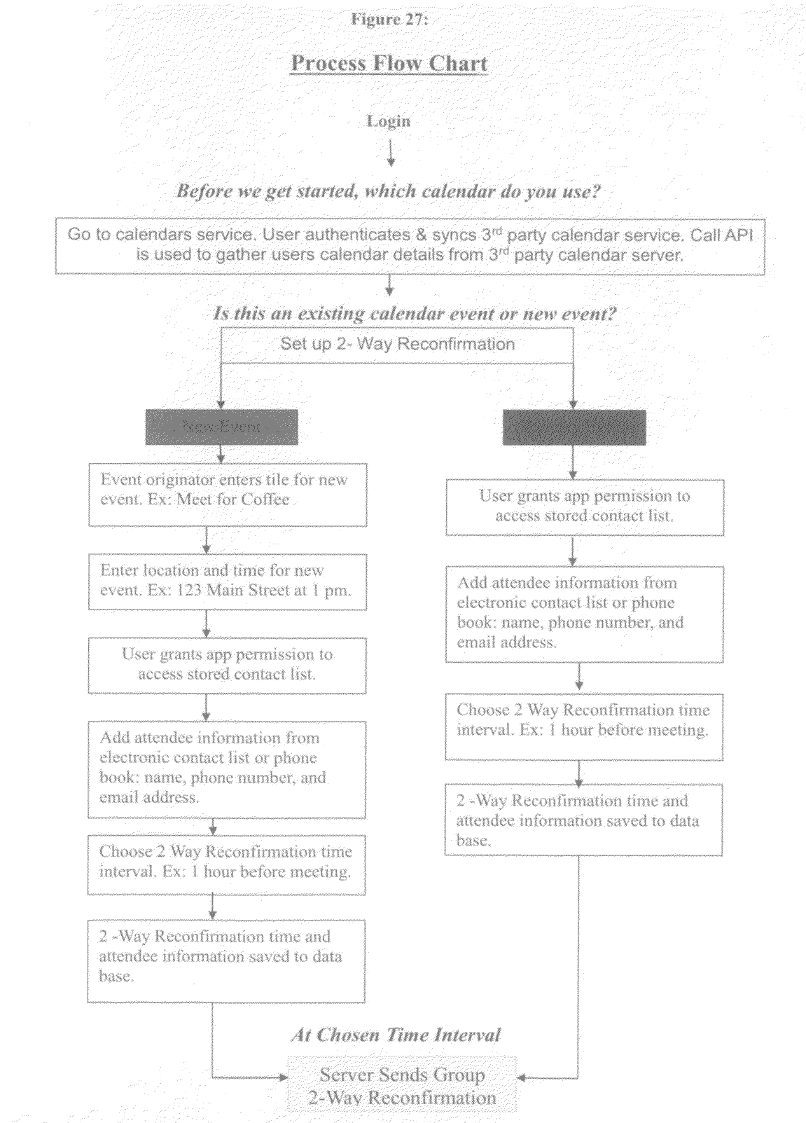

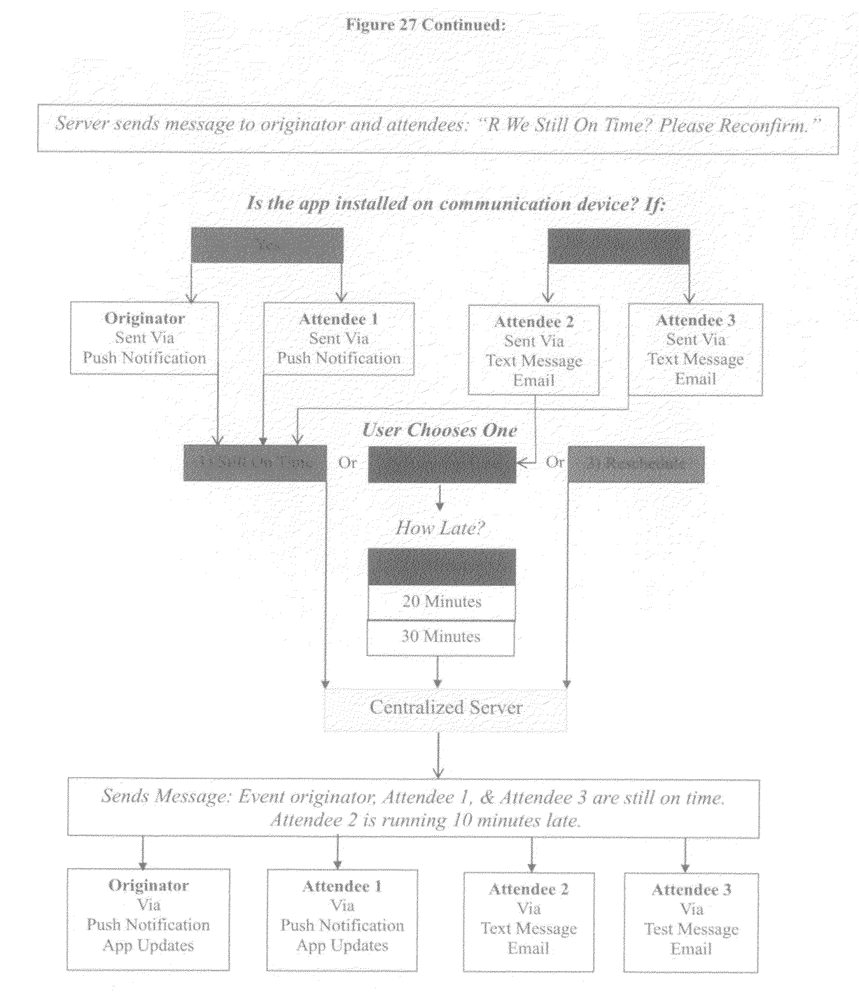

1) A methodical approach to reminding meeting attendees to synchronize their expected time of arrival with the meeting group, the method comprising:
Syncing 3^{rd} party calendar accounts.
Adding attendee information such as name, phone number and email address to a new or existing calendar event.
Setting and storing sever-executable instructions for determining when to send a 2-Way reconfirmation to meeting attendees.
Sending a 2-Way reconfirmation message to meeting attendees with a click-able web link or action button leading to a user interface in which a response can be sent to the server.
A user interface displaying action buttons to permit the manual sending of expected time of arrival by a human operator to a centralized server.
A client program aggregating the wait information for meeting attendees from a database; and a centralized server sending and displaying the wait information to all meeting attendees.
The method of claim 1 wherein receiving a request for the expected time of arrival by email.
The method of claim 1 wherein receiving a request for the expected time of arrival by a text message phone number.
The method of claim 1 wherein receiving a request for the expected time of arrival by push notification.
The method of claim 1 wherein sending the expected time of arrival comprises transmitting the wait time information via email using an electronic communication device. Communication of time status can be accomplished using a data linked vehicle head unit that supports electronics communication devices or other electronic communication device such as a desktop or laptop computer, tablet, mobile device or smart-watch or smart accessory that may be worn, imbedded into or controlled by a human operator.
The method of claim 1 wherein sending the expected time of arrival comprises transmitting the wait time information via SMS using an electronic communication device. Communication of time status can be accomplished using a data linked vehicle head unit that supports electronics communication devices or other electronic communication device such as a desktop or laptop computer, tablet, mobile device or smart-watch or smart accessory that may be worn, imbedded into or controlled by a human operator.
The method of claim 1 wherein sending the expected time of arrival comprises transmitting the wait information via Push Notification using an electronic communication device. Communication of time status can be accomplished using a data linked vehicle head unit that supports electronics communication devices or other electronic communication device such as a desktop or laptop computer, tablet, mobile device or smart-watch or smart accessory that may be worn, imbedded into or controlled by a human operator.

2) A service provider search feature based on average customer wait time. The unique search results comprising:
Search ranking based on average customer wait time. Wait time being an average measure of how far the service provider deviates from calendar event start times. For example, Dr. ABC has an average wait time of 5 minutes. This means patients are usually left waiting for on average 5 minutes past the agreed start-time of their appointment event. While, Dr. EFG has an average wait time of 10 minutes. Since Dr. ABC has a lower average wait time he will show up first in search results. Average customer wait time is calculated based on the Time Sync responses of service provider. Ex: Still On Time, Running_Minutes Ahead, Running_minutes late, or Sorry can't make it.
